(19) United States
(12) Patent Application Publication
(10) Pub. No.: US 2008/0096550 A1
(43) Pub. Date: Apr. 24, 2008

(54) Automatic replacement of a mobile sub-scriber identity code

(75) Inventor: Petteri Mandelin, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/585,100

(22) Filed: Oct. 24, 2006

(51) Int. Cl. H04Q 7/20

(52) U.S. Cl. 455/425

(57) ABSTRACT

The invention allows replacing a mobile subscriber identity code automatically. A record is kept of mobile subscriber identity code utilizing network elements. A notification about a replaced mobile subscriber identity code is received. In response, the mobile subscriber identity code utilizing network elements are updated in regards to the replaced mobile subscriber identity code.

### BACKGROUND OF THE INVENTION

1. Field of the Invention

The invention relates to telecommunications. In particular, the invention relates to a novel and improved automatic replacement of a mobile subscriber identity code.

2. Description of the Related Art

Digital cellular telecommunications is developing rapidly. On the one hand, the underlying technology is being enhanced to facilitate faster transmission rates. On the other hand, more and more new services are being introduced. In particular, new techniques are being introduced which seek to integrate conventional circuit-switched cellular telecommunications with packet switched communication networks, such as the Internet.

Digital cellular telecommunications techniques utilize one or more subscriber specific identity codes to identify subscribers. In addition to allowing calls and messages to be transferred to and from subscribers, identification allows e.g. providing user specific services.

Commonly used mobile subscriber identity codes include International Mobile Subscriber Identity (IMSI), and Mobile Subscriber International ISDN Number (MSISDN) where ISDN stands for Integrated Services Digital Network. The Mobile Subscriber ISDN Number is a unique international telephone number of a subscriber. The International Mobile Subscriber Identity is a unique number that is associated with each mobile subscriber. Typically, the International Mobile Subscriber Identity is stored in a Subscriber Identity Module which in turn is typically implemented as a smart card, i.e. separate from the handset. The International Mobile Subscriber Identity is sent by the handset to the network and is used to e.g. look up the other details of the subscriber in a Home Location Register (HLR).

The International Mobile Subscriber Identity and the Mobile Subscriber International ISDN Number are used e.g. in Global System for Mobile Communications (GSM) which is a second generation (2G) mobile telecommunications system. In addition, the International Mobile Subscriber Identity and Mobile Subscriber International ISDN Number are typically used in third generation mobile telecommunications systems, such as 3rd Generation Partnership Project (3GPP) telecommunications systems.

In addition to being stored in the Subscriber Identity Module, the International Mobile Subscriber Identity and the Mobile Subscriber International ISDN Number are stored in the Home Location Register which comprises a central database that contains details of each mobile subscriber authorized to use the network.

Furthermore, in addition to the Home Location Register, today there are also numerous other network elements in which copies of at least one of the International Mobile Subscriber Identity and the Mobile Subscriber International ISDN Number are stored. Typically such network elements utilize the International Mobile Subscriber Identity and/or the Mobile Subscriber International ISDN Number as a primary key for accessing subscriber data. Such network elements include e.g. Consequently, if the International Mobile Subscriber Identity and/or Mobile Subscriber International ISDN Number of a given user is changed for some reason, these copies of the International Mobile Subscriber Identity and/or Mobile Subscriber International ISDN Number stored in these other network elements must also be changed.

Furthermore, today there are also other mobile subscriber identity codes in addition to the above described International Mobile Subscriber Identity and Mobile Subscriber International ISDN Number that have been brought about by the newly developed services and techniques. Typically, these additional mobile subscriber identity codes are derived from or otherwise depend on International Mobile Subscriber Identity or Mobile Subscriber International ISDN Number. Consequently, if the International Mobile Subscriber Identity or Mobile Subscriber International ISDN Number of a given user is changed for some reason, these additional mobile subscriber identity codes associated with the user must also be amended accordingly.

Internet Protocol Multimedia Subsystem or IP Multimedia Subsystem (IMS) is a 3GPP standardized arrangement for providing multimedia services that complement the services provided by the circuit switched core network of a cellular telecommunications system. IP Multimedia Subsystem uses a Voice-over-IP (VoIP) implementation based on a 3GPP standardized implementation of Session Initiation Protocol (SIP), and runs over Internet Protocol (IP).

With IP Multimedia Subsystem, two additional subscriber identity codes are introduced: IP Multimedia Private User Identity and IP Multimedia Public User Identity. They are both Uniform Resource Identifiers (URI), that may consist of digits (typically called a TEL-URI), or that may be alphanumeric (typically called a SIP-URI). The IP Multimedia Public User Identity is used e.g. by a subscriber for requesting communications to other users. The IP Multimedia Public User Identity of a subscriber is typically generated from the Mobile Subscriber International ISDN Number of the subscriber.

The IP Multimedia Private User Identity and the IP Multimedia Public User Identity are typically stored in a Home Subscriber Server (HSS) which comprises a master user database that supports the IP Multimedia Subsystem network entities that actually handle the calls or sessions. In addition, the Home Subscriber Server typically stores subscription-related information (often called user profiles), performs authentication and authorization of the user, and can provide information about the physical location of the user. User Mobility Server (UMS) is a part of the Home Subscriber Server that participates in mobility management, location query, and authentication procedures, and provides user and service mobility information.

Push to talk over Cellular (PoC) is a walkie-talkie type service that is provided over a cellular telecommunications network. In other words, Push to talk over Cellular allows real time one-to-one and one-to-many voice communication which is half duplex—while one person speaks, the other(s) listen. Typically, Push to talk over Cellular is implemented as a Voice-over-IP application running over General Packet Radio Service (GPRS) or enhanced GPRS (EGPRS) networks. Push to talk Register (PoC-R) is a centralized subscriber database of the Push to talk over Cellular core network that is used for e.g. provisioning.

Intelligent Content Delivery (ICD) is a content delivery service in the packet switched core network that involves rule-based content analysis and traffic differentiation, and service and subscription provisioning, and allows the mobile operator to perform differentiated charging for specific traffic types and transactions and for time or access based services. Intelligent Content Delivery supports prepaid real-time charging of packet traffic.

It is to be understood that herein the term “provisioning” is used to refer to a functionality of brokering for subscription management and subscriber service activation. For example, when a new subscriber is added or a new service is added for a subscriber, provisioning is typically used to forward relevant subscriber information to the correct network elements to allow the activation of the subscription or services.

There are sometimes situations that require an International Mobile Subscriber Identity or a Mobile Subscriber International ISDN Number of a given subscriber to be replaced with a new one. For example, the Subscriber Identity Module card of the subscriber may have been stolen, or an authentication algorithm has changed in the network, or the subscriber wants to change telephone number.

A functionality called “Automatic IMSI replacement” is known. A subscriber is given a new Subscriber Identity Module card containing a new International Mobile Subscriber Identity but an old Mobile Subscriber International ISDN Number. “Attach IMSI” is allocated to the subscriber in the Home Location Register. After placing the new Subscriber Identity Module card in the handset, the replacement of the International Mobile Subscriber Identity is detected by the Home Location Register which then proceeds to delete the old International Mobile Subscriber Identity stored in the Home Location Register and store the new International Mobile Subscriber Identity instead.

However, there exists no mechanism for automatically informing any other network element but the Home Location Register about the replaced International Mobile Subscriber Identity or about any other replaced mobile subscriber identity code so that these other network elements could update their respective data. Rather, today these other network elements must be updated manually by an operator. Yet, as described above, there are already a significant amount of services and networks elements providing them that depend on accurate and up-to-date information in regards to mobile subscriber identity codes, and it is highly likely that the amount of such services and networks elements will continue to increase rapidly.

Therefore, an object of the present invention is to alleviate the problems described above and to introduce a solution that allows automatic replacement of a mobile subscriber identity code.

### SUMMARY OF THE INVENTION

A first aspect of the present invention is a method in which a record is kept of mobile subscriber identity code utilizing network elements. Then, a notification about a replaced mobile subscriber identity code is received. In response, the mobile subscriber identity code utilizing network elements are updated in regards to the replaced mobile subscriber identity code.

A second aspect of the present invention is an apparatus which comprises an administrator configured to keep a record of mobile subscriber identity code utilizing network elements. The apparatus of the second aspect further comprises a receiver configured to receive a notification about a replaced mobile subscriber identity code. The apparatus of the second aspect further comprises an updater configured to update the mobile subscriber identity code utilizing network elements in regards to the replaced mobile subscriber identity code.

A third aspect of the present invention is a system which comprises at least one mobile subscriber identity code utilizing network element. The system of the third aspect further comprises a subscriber data base. The system of the third aspect further comprises a provisioning manager. The subscriber data base comprises a detector configured to detect a replaced mobile subscriber identity code. The subscriber data base further comprises a notifier configured to dispatch a notification about the detected replacement. The provisioning manager comprises an administrator configured to keep a record of the at least one mobile subscriber identity code utilizing network element. The provisioning manager further comprises a receiver configured to receive the dispatched notification about the replaced mobile subscriber identity code. The provisioning manager further comprises an updater configured to update the at least one mobile subscriber identity code utilizing network element in regards to the replaced mobile subscriber identity code.

A fourth aspect of the present invention is an apparatus which comprises an administration means for keeping a record of mobile subscriber identity code utilizing network elements. The apparatus of the fourth aspect further comprises a receiving means for receiving a notification about a replaced mobile subscriber identity code. The apparatus of the fourth aspect further comprises an updating means for updating the mobile subscriber identity code utilizing network elements in regards to the replaced mobile subscriber identity code.

A fifth aspect of the present invention is a computer program embodied on a computer readable medium, the computer program controlling a data-processing device to perform the steps of:

keeping a record of mobile subscriber identity code utilizing network elements;

receiving a notification about a replaced mobile subscriber identity code; and

updating the mobile subscriber identity code utilizing network elements in regards to the replaced mobile subscriber identity code.

In an embodiment of the invention, the mobile subscriber identity code comprises at least one of an International Mobile Subscriber Identity, and a Mobile Subscriber International ISDN Number.

In an embodiment of the invention, the mobile subscriber identity code comprises a mobile subscriber identity code derived from an International Mobile Subscriber Identity or a Mobile Subscriber International ISDN Number.

In an embodiment of the invention, the apparatus of the second aspect is arranged in a provisioning manager configured to broker for subscription management and subscriber service activation.

In an embodiment of the invention, the mobile subscriber identity code utilizing network elements include at least one of a User Mobility Server, a Push to talk Register, an Online Service Controller, a profile server, a terminal management server, a subscriber specific service data provisioning element, and a Domain Name System/Electronic Numbering mapping element.

The invention allows replacing a mobile subscriber identity code automatically. As a result, downtime of subscriber services is reduced significantly, since the telecommunications network operator is not required to update each mobile subscriber identity code utilizing network element manually one by one.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a system according to an embodiment of the present invention, and

FIG. 2 is a diagram illustrating a method according to an embodiment of the present invention.

### DETAILED DESCRIPTION OF THE PREFERRED EMBODIMENTS

Reference will now be made in detail to the embodiments of the invention, examples of which are illustrated in the accompanying drawings.

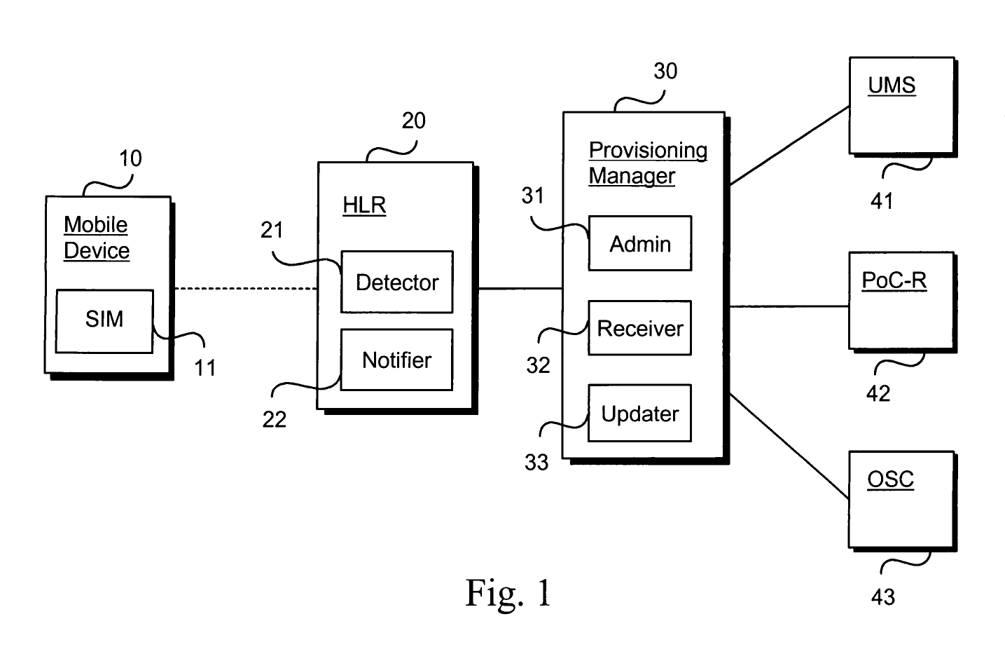

FIG. 1 illustrates a system according to an embodiment of the present invention. The system of the embodiment of the invention illustrated in FIG. 1 comprises a mobile device 10. The mobile device 10 comprises a Subscriber Identity Module 11 which stores an International Mobile Subscriber Identity and a Mobile Subscriber International ISDN Number, both associated with the subscriber having the Subscriber Identity Module 11.

The system of the embodiment of the invention illustrated in FIG. 1 further comprises a subscriber data base 20 which in the example of FIG. 1 is a Home Location Register. The Home Location Register 20 comprises a detector 21 configured to detect a replaced mobile subscriber identity code, and a notifier 22 configured to dispatch a notification about the detected replacement to a provisioning manager 30. In an embodiment, the detector 21 is implemented using the above described “Automatic IMSI replacement” functionality. Furthermore, the detector 21 and the notifier 22 may be implemented as software, as hardware, or as a combination of software and hardware.

The system of the embodiment of the invention illustrated in FIG. 1 further comprises the provisioning manager 30. The provisioning manager 30 comprises an administrator 31 which is configured to keep a record of mobile subscriber identity code utilizing network elements 41, 42, 43. That is, the administrator 31 is configured to maintain information about which network elements utilize at least one mobile subscriber identity code and which therefore need to be updated if the at least one mobile subscriber identity code is changed.

Furthermore, the administrator 31 is configured to maintain information about whether a given network element utilizes at least one of the International Mobile Subscriber Identity and the Mobile Subscriber International ISDN Number as such, e.g. as a primary key for accessing subscriber data, or whether the given network element utilizes an additional mobile subscriber identity code derived from or otherwise depending on at least one of the International Mobile Subscriber Identity and the Mobile Subscriber International ISDN Number. Furthermore, in the latter case, the administrator 31 is configured to maintain information about how the additional mobile subscriber identity code is derived from or otherwise depends on the at least one of the International Mobile Subscriber Identity and the Mobile Subscriber International ISDN Number.

The provisioning manager 30 further comprises a receiver 32 which is configured to receive from the Home Location Register 20 the notification concerning the replaced mobile subscriber identity code. The provisioning manager 30 further comprises an updater 33 which is configured to update the mobile subscriber identity code utilizing network elements 41, 42, 43 in regards to the replaced mobile subscriber identity code. In an embodiment, the provisioning manager 30 is a Nokia Profile Manager provided by the applicant. Furthermore, the administrator 31, the receiver 32 and the updater 33 may be implemented as software, as hardware, or as a combination of software and hardware.

In an embodiment, the updater 33 is configured to utilize at least one existing interface for performing the above described updating of at least one of the mobile subscriber identity code utilizing network elements. Such an existing interface may include e.g. a provisioning interface used by the provisioning manager 30 in provisioning subscriber data to network elements, such as e.g. the mobile subscriber identity code utilizing network elements 41, 42, 43.

In another embodiment, the updater 33 is configured to perform the above described updating of at least one of the mobile subscriber identity code utilizing network elements by modifying mobile subscriber identity code related data in the at least one of the mobile subscriber identity code utilizing network elements via a communication logic implemented between the updater 33 and the at least one of the mobile subscriber identity code utilizing network elements.

The system of the embodiment of the invention illustrated in FIG. 1 further comprises the mobile subscriber identity code utilizing network elements 41, 42, 43. In FIG. 1, the network element 41 is a User Mobility Server. As described above, the User Mobility Server is a part of a Home Subscriber Server (not illustrated in FIG. 1) used in IP Multimedia Subsystems that participates in mobility management, location query, and authentication procedures, and provides user and service mobility information.

In FIG. 1, the network element 42 is a Push to talk Register. As described above, the Push to talk Register is a centralized subscriber database of Push to talk over Cellular core network that is used for e.g. provisioning. Further in FIG. 1, the network element 43 is an Online Service Controller. Online Service Controller is a network element for providing a combination of offline and online charging mechanisms on a single platform, as well as central charging logic management independent of the charging method.

Other network elements that can be updated with the updater 33 of the present invention in regards to a replaced mobile subscriber identity code include a Domain Name System (DNS)/Electronic Numbering (ENUM) mapping element for mapping E.164 number space addresses (such as a typical Mobile Subscriber International ISDN Number) into Domain Name System. Such a mapping includes translation into Session Initiation Protocol Uniform Resource Identifiers (SIP-URI).

The network elements that can be updated with the updater 33 of the present invention in regards to a replaced mobile subscriber identity code further include a profile server, e.g. a Nokia Profile Server provided by the applicant. Herein the term “profile server” refers to a network element that provides centralized storage and retrieval services for subscribers' service settings and other subscriber information in Intelligent Content Delivery.

The network elements that can be updated with the updater 33 of the present invention in regards to a replaced mobile subscriber identity code further include a terminal management server, e.g. a Nokia Terminal Management Server provided by the applicant. Herein the term “terminal management server” refers to a network element that allows a network operator or a subscriber to set an original set of parameters or modify an existing set of parameters in the mobile device. More particularly, the terminal management server is utilized to forward correct settings to a mobile device in response to the subscriber subscribing an IP Multimedia Subsystem service or a Push to talk over Cellular service.

The network elements that can be updated with the updater 33 of the present invention in regards to a replaced mobile subscriber identity code further include a subscriber specific service data provisioning element, e.g. mCreate provided by the applicant.

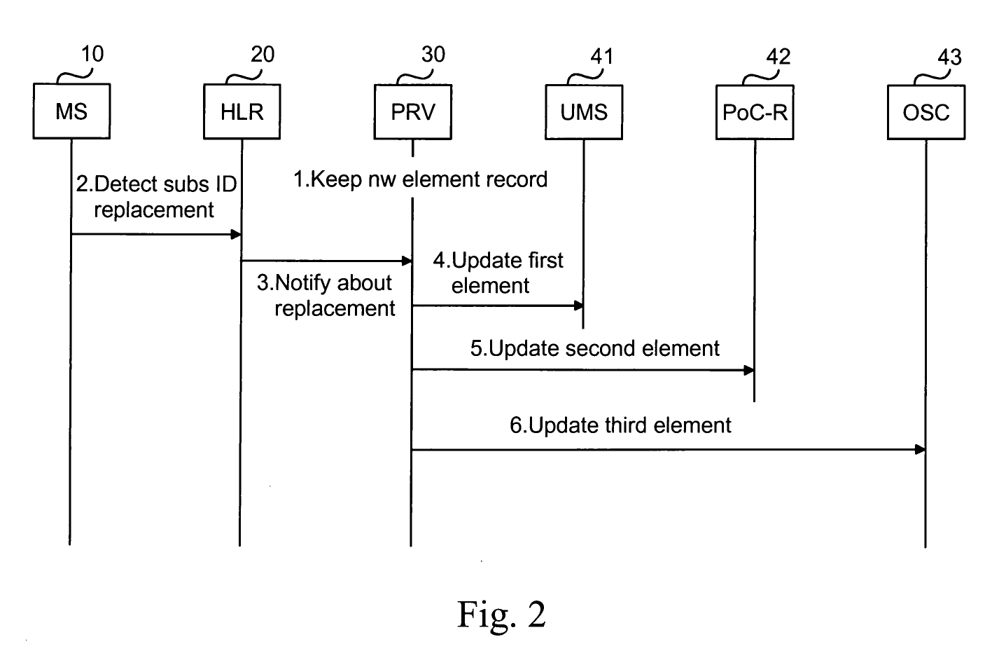

FIG. 2 illustrates a method according to an embodiment of the present invention. First, a record is being maintained in the provisioning manager 30 about the mobile subscriber identity code utilizing network elements 41, 42, 43. Then, the subscriber using the mobile device 10 inserts in it a new Subscriber Identity Module card comprising a new International Mobile Subscriber Identity but an old Mobile Subscriber International ISDN Number. When the subscriber next connects to the telecommunications network, the change in International Mobile Subscriber Identity is detected at the Home Location Register 20, step 2. In response, the Home Location Register 20 notifies the provisioning manager 30 about the replaced International Mobile Subscriber Identity, step 3. In response, the provisioning manager 30 updates those network elements 41, 42, 43 that directly or indirectly utilize International Mobile Subscriber Identities in regards to the replaced International Mobile Subscriber Identity, steps 4-6.

The exemplary embodiments can include, for example, any suitable servers, workstations, personal computers, laptop computers, personal digital assistants, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network, Packet Data Networks, the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed is:

1. A method, comprising:
keeping a record of mobile subscriber identity code utilizing network elements;
receiving a notification about a replaced mobile subscriber identity code; and
updating the mobile subscriber identity code utilizing network elements in regards to the replaced mobile subscriber identity code.

2. The method according to claim 1, wherein the updating in regards to the mobile subscriber identity code comprises updating in regards to at least one of an international mobile subscriber identity or a mobile subscriber international integrated services digital network number.

3. The method according to claim 1, wherein the updating in regards to the mobile subscriber identity code comprises updating in regards to a mobile subscriber identity code derived from an international mobile subscriber identity or a mobile subscriber international integrated services digital network number.

4. An apparatus, comprising:
an administrator configured to keep a record of mobile subscriber identity code utilizing network elements;
a receiver configured to receive a notification about a replaced mobile subscriber identity code; and
an updater configured to update the mobile subscriber identity code utilizing network elements in regards to the replaced mobile subscriber identity code.

5. The apparatus according to claim 4, wherein the apparatus is arranged in a provisioning manager configured to broker for subscription management and subscriber service activation.

6. The apparatus according to claim 4, wherein the mobile subscriber identity code utilizing network elements include at least one of a user mobility server, a push to talk register, an online service controller, a profile server, a terminal management server, a subscriber specific service data provisioning element, or a domain name system/electronic numbering mapping element.

7. The apparatus according to claim 4, wherein the updater is configured to update in regards to the mobile subscriber identity code by updating in regards to at least one of an international mobile subscriber identity or a mobile subscriber international integrated services digital network number.

8. The apparatus according to claim 4, wherein the updater is configured to update in regards to the mobile subscriber identity code by updating in regards to a mobile subscriber identity code derived from an international mobile subscriber identity or a mobile subscriber international integrated services digital network number.

9. A system, comprising:
at least one mobile subscriber identity code utilizing network element;
a subscriber data base comprising
a detector configured to detect a replaced mobile subscriber identity code, and
a notifier configured to dispatch a notification about the detected replacement;
a provisioning manager comprising
an administrator configured to keep a record of the at least one mobile subscriber identity code utilizing network element,
a receiver configured to receive the dispatched notification about the replaced mobile subscriber identity code, and
an updater configured to update the at least one mobile subscriber identity code utilizing network element in regards to the replaced mobile subscriber identity code.

10. An apparatus, comprising:
an administration means for keeping a record of mobile subscriber identity code utilizing network elements;
a receiving means for receiving a notification about a replaced mobile subscriber identity code; and
an updating means for updating the mobile subscriber identity code utilizing network elements in regards to the replaced mobile subscriber identity code.

11. The apparatus according to claim 10, wherein the apparatus is arranged in a provisioning manager configured to broker for subscription management and subscriber service activation.

12. The apparatus according to claim 10, wherein the mobile subscriber identity code utilizing network elements include at least one of a user mobility server, a push to talk register, an online service controller, a profile server, a terminal management server, a subscriber specific service data provisioning element, or a domain name system/electronic numbering mapping element.

13. The apparatus according to claim 10, wherein the updating means is configured to update in regards to the mobile subscriber identity code by updating in regards to at least one of an international mobile subscriber identity or a mobile subscriber international integrated services digital network number.

14. The apparatus according to claim 10, wherein the updating means is configured to update in regards to the mobile subscriber identity code by updating in regards to a mobile subscriber identity code derived from an international mobile subscriber identity or a mobile subscriber international integrated services digital network number.

15. A computer program embodied on a computer readable medium, the computer program controlling a data-processing device to perform:
keeping a record of mobile subscriber identity code utilizing network elements;
receiving a notification about a replaced mobile subscriber identity code; and
updating the mobile subscriber identity code utilizing network elements in regards to the replaced mobile subscriber identity code.

16. The computer program according to claim 15, wherein the computer program is installed in a provisioning manager configured to broker for subscription management and subscriber service activation.

17. The computer program according to claim 15, wherein the mobile subscriber identity code utilizing network elements include at least one of a user mobility server, a push to talk register, an online service controller, a profile server, a terminal management server, a subscriber specific service data provisioning element, or a domain name system/electronic numbering mapping element.

18. The computer program according to claim 15, wherein the updating in regards to the mobile subscriber identity code comprises updating in regards to at least one of an international mobile subscriber identity or a mobile subscriber international integrated services digital network number.

19. The computer program according to claim 15, wherein the updating in regards to the mobile subscriber identity code comprises updating in regards to a mobile subscriber identity code derived from an international mobile subscriber identity or a mobile subscriber international integrated services digital network number.
